(19) United States
(12) Patent Application Publication
(10) Pub. No.: US 2018/0033342 A1
(43) Pub. Date: Feb. 1, 2018

(54) DIGITAL SHELF TAG SYSTEM

(71) Applicants: Oliver Olibrice, Orlando, FL (US); Troy Ather, Winter Springs, FL (US)

(72) Inventors: Oliver Olibrice, Orlando, FL (US); Troy Ather, Winter Springs, FL (US)

(21) Appl. No.: 15/220,056

(22) Filed: Jul. 26, 2016

(51) Int. Cl. G09F 3/20; G06K 19/077; G06F 3/0488; G09F 27/00; G09G 5/00; G06Q 10/08; G06F 3/14

(52) U.S. Cl. CPC G09F 3/208; G06Q 10/087; G06K 19/07705; G06F 3/1446; G09F 3/204; G09F 27/00; G09G 5/006; G06F 3/0488

(57) ABSTRACT

A digital shelf tag system can include one or more primary shelf tag units and one or more secondary shelf tag units. Each shelf tag unit includes a main body, an internal controller and a display screen. A shelf tag bracket is provided along the main body and secures the shelf tag unit onto a merchandise shelf. The main body includes an internal layer of insulation that encapsulates the internal controller. An externally located system controller communicates with each of the shelf tag units and a plurality of authorized users pertaining to content that is displayed on the display screens.

### TECHNICAL FIELD

The present invention relates generally to merchandise tags, and more particularly to a digital display system for displaying product and advertising information on a store shelf.

### BACKGROUND

The statements in this section merely provide background information related to the present disclosure and may not constitute prior art.

Virtually every market and/or convenience store has at least one refrigerated display case having a plurality of shelves for displaying merchandise such as food and beverage items. Each of these shelves commonly includes an outer edge onto which one or more tags are provided. These tags are typically constructed from paper or plastic, and contain product information such as the name, price and/or product code for the merchandise offered for sale.

Although such tags work well to display the price of an item, they do nothing to actually encourage consumers to purchase the item. In addition, the use and implementation of so many individual tags can be burdensome and expensive for store owners to maintain. For example, store owners must constantly replace product tags each time a new product is introduced and/or whenever the price of an existing product is altered. This results in a substantial amount of commercial waste each year, as hundreds of millions of paper/plastic tags are discarded and ultimately end up in our landfills. Moreover, the time involved in constantly printing and replacing such product tags is expensive in terms of labor costs, because store owners must pay an employee to physically replace tags in situations like those described above.

Accordingly, it would be beneficial to provide a digital shelf tag system which can be secured onto any type of merchandise display shelf in order to eliminate the drawbacks described above.

### SUMMARY OF THE INVENTION

The present invention is directed to a digital shelf tag system. One embodiment of the present invention can include one or more primary shelf tag units each including a main body, an internal controller and a display screen. The primary shelf tag units can be secured onto a merchandise shelf at a location where merchandise is sold. The display screen can be in communication with a system control unit and can display any type of content such as dynamic advertisements and/or product/pricing information pertaining to the merchandise on the shelf.

In another embodiment, the primary shelf tag can be pivotally secured onto the merchandise shelf, and the system can also include one or more secondary shelf tag units. Each of the secondary shelf tag units can also be secured onto a merchandise shelf and can display product/pricing information pertaining to the merchandise on the shelf.

In yet another embodiment, each of the primary and secondary shelf tag units can communicate with an authorized user directly or through the system controller. The system can set permissions as to the type of content that can be provided by, or adjusted by each authorized user.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a simplistic operating environment of a digital shelf tag system that is useful for understanding the inventive concepts disclosed herein.

FIG. 2A is a front side view of a primary digital shelf tag unit, in accordance with one embodiment of the invention.

FIG. 2B is a front side view of a secondary digital shelf tag unit, in accordance with one embodiment of the invention.

FIG. 3 is a side view of a shelf attachment bracket for use with the digital shelf tag unit, in accordance with one embodiment of the invention.

FIG. 4 is a simplified block diagram of an internal controller of the digital shelf tag unit, in accordance with one embodiment of the invention.

FIG. 5 is a simplified block diagram of the system control unit, in accordance with one embodiment of the invention.

FIG. 6 is a perspective view of the digital shelf tag system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described and illustrated for use with a refrigerated display, those of skill in the art will recognize that the inventive concepts disclosed herein can be utilized with any type of shelving/display systems where it is useful to provide pricing and/or advertising information to a consumer. As such, the below described system is not to be construed as limiting to any particular use or industry.

As described herein, the term “pivotally connected” “rotatably secured” and all derivatives shall be used interchangeably to describe a situation wherein two or more objects are joined together in a manner that allows one or both of the objects to pivot and/or rotate about or in relation to the other object. Several nonlimiting examples include traditional single hinge mechanisms, pivoting couplers and/or swivel flanges, for example.

As described herein, the term “removably secured” and derivatives thereof shall be used to describe a situation wherein two or more objects are joined together in a non-permanent manner so as to allow the same objects to be repeatedly joined and separated. This can be accomplished through the use of any number of commercially available connectors such as opposing strips of hook and loop material (i.e. Velcro®), magnetic elements, and compression fittings such as various shelving clips, clamps, nuts and bolts, hooks and/or snaps, for example. Moreover, the term “permanently secured” shall be used to describe a situation wherein two or more objects are joined together in a manner so as to prevent the same objects from being separated. Several nonlimiting examples include various adhesives such as glue or resin, welds, and/or through the use of a singular piece of material machined or molded to form a unitary element, for example.

As described herein, the term “content,” and derivatives thereof shall include any type of sound and/or images (e.g., still, motion, live, generated), which can be presented to a user by the device. Content can include, but is not limited to: background, environmental, advertising banners, product pricing information, commercials, videos, QR codes and the like, for example.

As described throughout this document, the term “complementary shape,” and “complementary dimension,” shall be used to describe a shape and size of a component that is identical to, or substantially identical to the shape and size of another identified component.

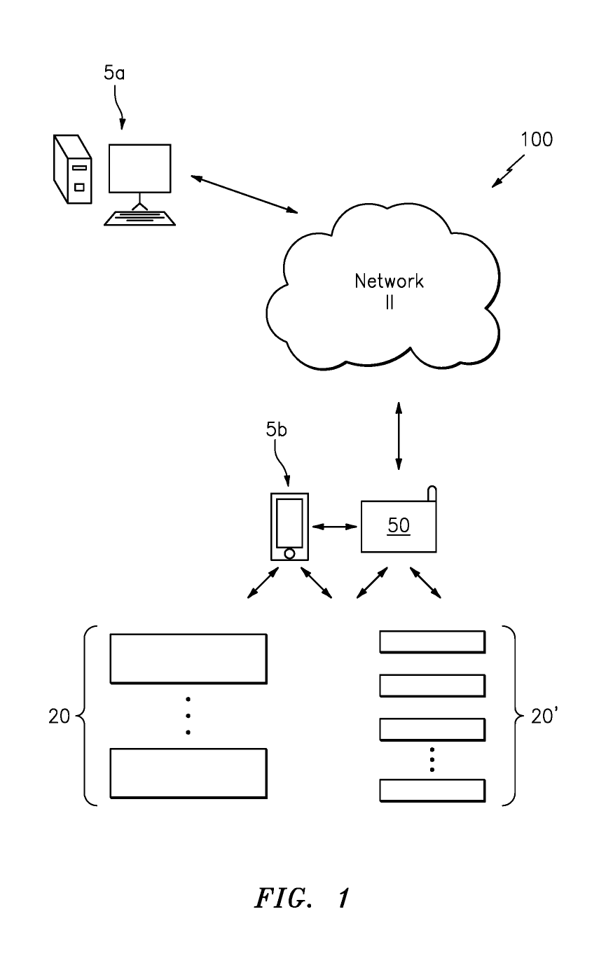

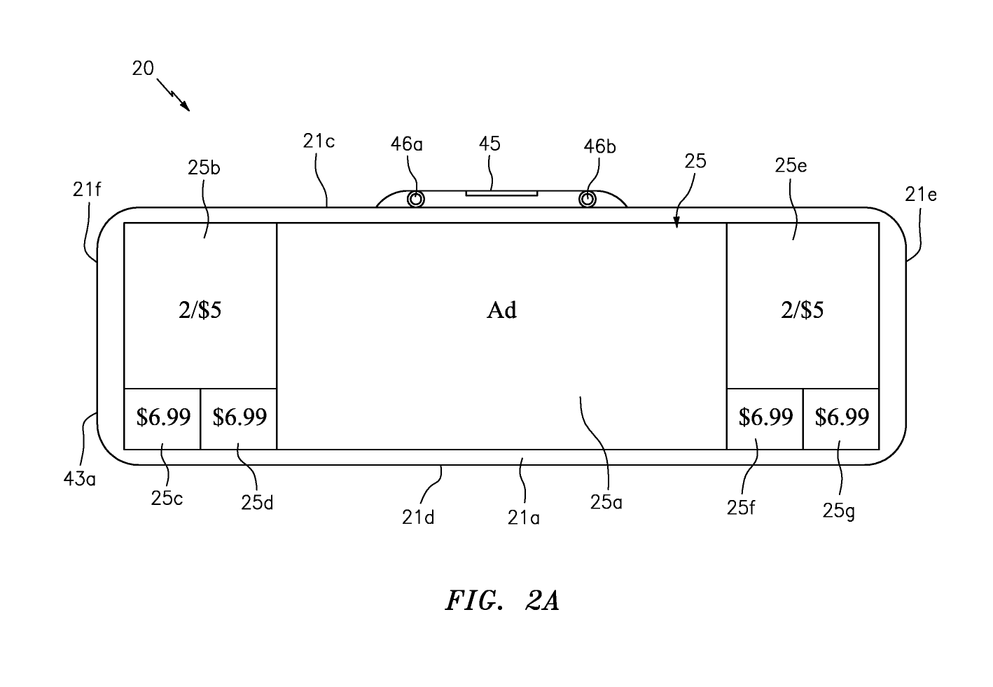

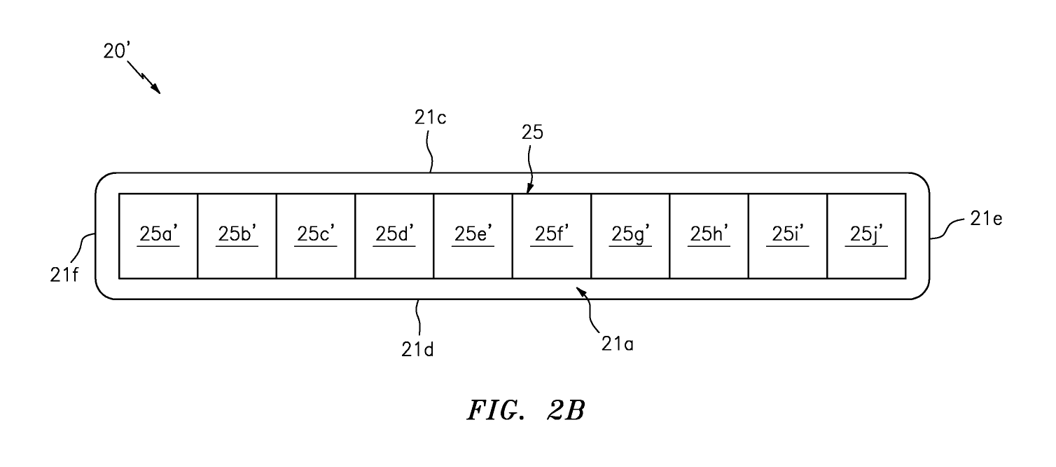

Various embodiments of a digital shelf tag display system 100 are provided with reference to FIGS. 1-6. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

FIG. 1 is a simplistic block diagram illustrating an exemplary system operating environment of the digital shelf tag display system 100 that is useful for understanding the inventive concepts disclosed herein. As shown, the system 100 can include, any number of primary and secondary digital shelf tag units 20 and 20′, respectively that are communicatively linked to a control unit 50 and/or one or more authorized users 5a and 5b over a network 11.

FIGS. 2A and 2B illustrate one embodiment of the primary and secondary digital shelf tag units for use with the system 100. As shown, each of the units can include an elongated, generally rectangular-shaped main body 21 having a front facing surface 21a, a rear facing surface 21b a top surface 21c, a bottom surface 21d and a pair of opposing side surfaces 21e and 21f. The main body can preferably be constructed from plastic and can house an internal controller 40 that is described below.

As various embodiments of the tag units are contemplated for use within refrigerated display cases, it is preferred that the interior walls of the main body include an insulating material such as foam, for example, to prevent the internal controller from freezing. Of course, the main body is not to be construed as limiting to the illustrated shape or construction material, as other embodiments are contemplated wherein the main body includes any number of different shapes, sizes, insulation and/or construction materials.

A display screen 25 can be positioned along the front facing surface of the main body 21a and can be controlled by the internal controller 40. The display screen 25 can include virtually any type of device capable of presenting information in a digital format to a user. Several nonlimiting examples include LCD displays, plasma displays, LED displays, electro-luminescent displays and the like. In various embodiments, the display screen 25 can also include or comprise a Graphic User Interface (GUI) capable of performing two way communication with a device user.

As shown in FIG. 2A, the display screen 25 of each primary digital shelf tag unit 20 can preferably be digitally segmented to include a dynamic content area 25a, for displaying information such as commercials and/or moving advertisements, for example. The screen can also include any number of other sections such as 25b, 25c, 25d, 25e, 25f and 25g, for example, in order to display any type of product specific information such as pricing and/or sale information, for example.

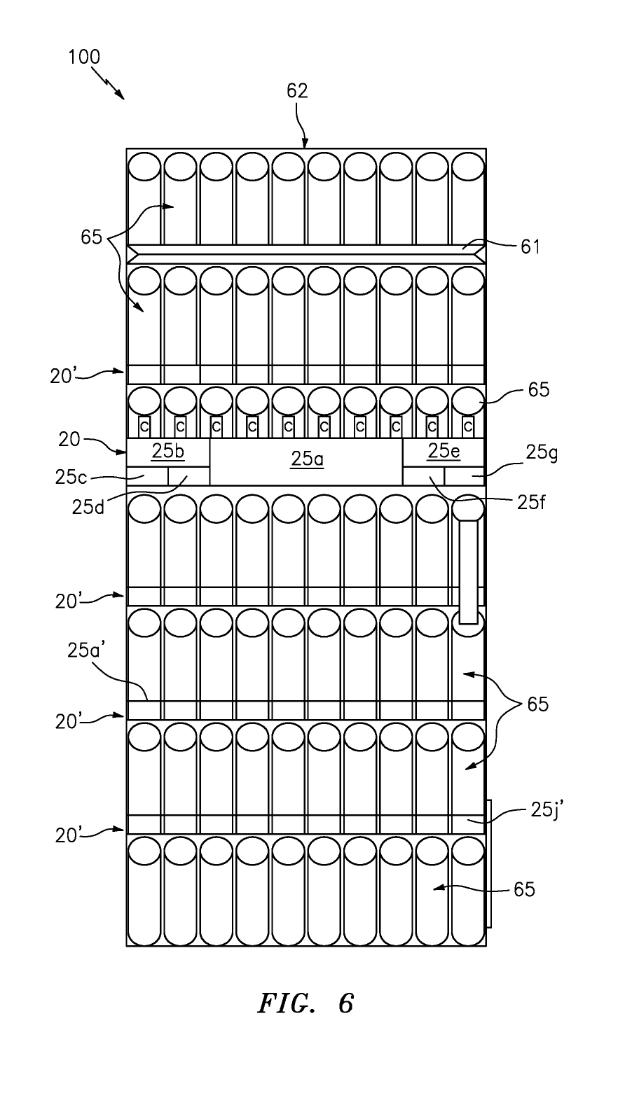

As shown in FIG. 2B, the display screen 25 of each secondary digital shelf tag unit 20′ can preferably be digitally segmented to include any number of different sections based on the size and number of items located on the shelf to which the tag unit 20′ is installed. For example, if a shelf contains ten cans of soda, the screen 25 can include ten distinct sections 25a′, 25b′ 25c′, 25d, 25e, 25f, 25h, 25i and 25j′, for example, each displaying the price of one of the cans of soda located directly above that section (See FIG. 6).

Although described above with regard to a particular number use and/or location of digital sections, this is for illustrative purposes only. To this end, the display screen of each digital shelf tag unit 20 and 20′ can be arranged to include any number of different sections, each having any number of different shapes and sizes suitable for displaying any type of content. Moreover, although illustrated as including a single display screen 25 that is positioned along an entirety of the front facing surface, this is for illustrative purposes only. As such, other embodiments are contemplated wherein one or more of the digital shelf tag units include any number of different display screens that are positioned along any portion of the main body.

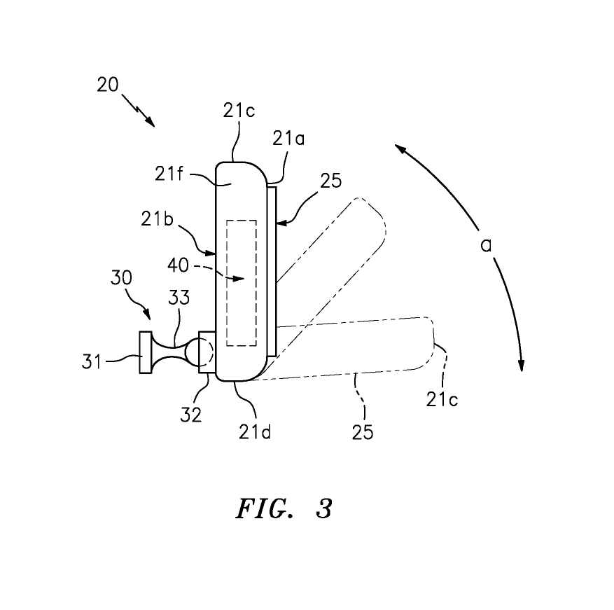

As shown in FIG. 3, each of the digital shelf tag units can further include one or more shelf attachment bracket(s) 30, which can be secured onto the main body 21, in order to secure the digital shelf tag unit onto a merchandise shelf. To this end, each bracket can include a first end having a clip/bracket 31 for removably engaging the shelf, and a second end 32 that is secured to the main body 21.

In various embodiments, one or more of the brackets 30 can further include a joint member 33 such as a spring loaded hinge, for example, which can allow the digital shelf tag unit to pivot/rotate (see arrow a) while remaining installed onto the shelf. Such a feature can advantageously allow the digital shelf tag unit to include a height that extends above the top portion of the shelf. In this regard, when the device is in use, a user can simply pull the selected beverage outward which will pivot the device forward (towards the user) so as to allow the selected product to be removed.

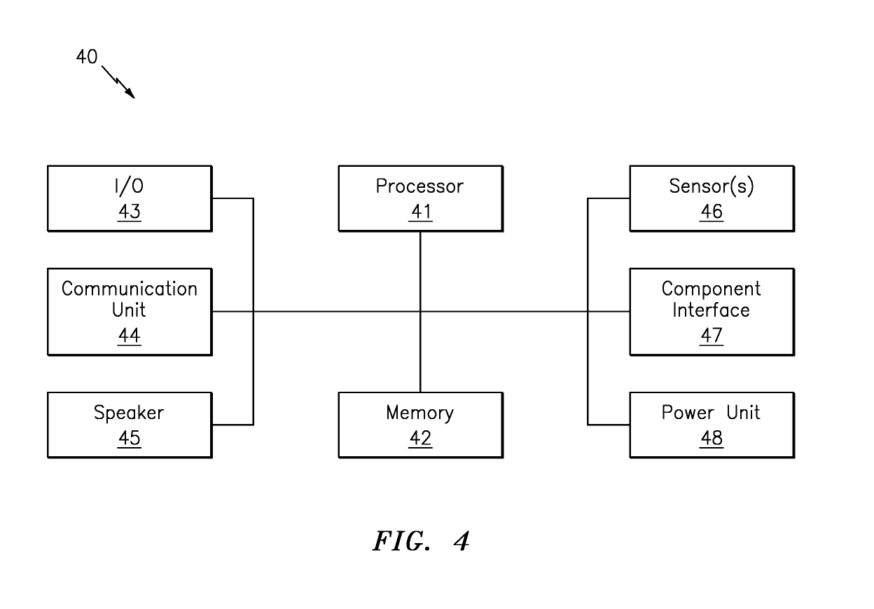

FIG. 4 is an exemplary block diagram of the internal controller 40 which can be provided within each of the digital shelf tag units 20 and 20′. As shown, the controller 40 can include any number of components such as a processor 41 that is conventionally connected to an internal memory 42, an input/output unit 43, a communication unit 44, a speaker 45, a sensor 46, an internal component interface unit 47, and/or a power source 48.

Although illustrated as separate elements, those of skill in the art will recognize that one or more system components may comprise, or include one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the below described functionality can be provided in place of, or in conjunction with the below described controller elements.

The processor/CPU 41 can act to execute program code stored in the memory 42 in order to allow the device to perform the functionality described herein. Likewise, a timer module can be provided as a function of the processor, and can function to accurately measure the passage of time. Processors and timers are extremely well known in the art, therefore no further description will be provided.

Memory 42 can act to store operating instructions in the form of program code for the processor 41 to execute. Although illustrated in FIG. 4 as a single component, memory 42 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a hard drive, for example. Additionally, memory 42 can also include one or more cache memories that provide temporary storage of at least some program code in order to reduce the number of times program code must be retrieved from the bulk storage device during execution. Each of these devices is well known in the art.

The input/output unit 43 can include any number of devices which can act to accept user inputs and provide instructions to the processor. In one preferred embodiment, each of the buttons can be connected to the processor 41 so as to activate different programmatic functions. For example, a push button 43a can act to initiate programming for instructing the processor 41 to switch the electronic components of the device between an ON and OFF state, initiate a Sleep mode, and/or to pair the communication unit with an external device, and so on.

The communication unit 44 can include any number of devices capable of communicating with an external processor enabled device such as the below described system control unit 50, for example. In one preferred embodiment, the communication unit can include a wireless network adapter for communicating wirelessly over a network 11 such as a local area network and/or the internet, for example. Of course, any number of other known transmission and reception mechanisms and protocols can also be utilized herein, several nonlimiting examples include near field communication, unique radio frequencies, infrared (IR), and/or a Bluetooth transceiver, for example, capable of allowing the device to also communicate directly with an external device such as a smartphone, or tablet computer that is running an App, for example (i.e., M2M). The communication unit can also include or comprise a physical connection such as a wireline cable or other such device.

The communication unit can allow each shelf tag unit to independently communicate with the below described system controller 50 and/or any number of other devices. For example, in one embodiment the internal communication unit can also send any type of content directly to a consumers device such as a smartphone, for example, utilizing near field communication. Such a feature can be initiated at the request of the consumer via the GUI two way interface, for example, and the content can include items such as coupons and/or links to various websites, for example.

The digital shelf tag units can include a speaker 45, which can function in a conventional manner to play audible sounds such as spoken words and/or music, for example. The speaker can preferably work in conjunction with the display 25 and can be controlled by the processor.

The digital shelf tag units can also include any number of different sensors 46, which can perform various functionality. For example, one sensor 46a can include a commercially available motion sensor which can be positioned along the main body, and can act to detect the presence of a user as they approach the shelf containing the device. Such a sensor can enable the display screen to immediately display content for a specific duration of time when the user is in the vicinity, and can go dormant or display static information when no user is detected.

In another embodiment, one or more of the digital shelf tag units can include another sensor 46b, which can function to detect and track the eye movements of a person. Such a feature can allow the device to capture consumer data regarding items that best attract the interest of a user. One suitable example of an eye movement sensor and capture system is described in U.S. Patent Publication No. US20050213792, the contents of which are incorporated herein by reference.

The internal component interface unit 47 can function to provide a communicative link between the processor 41 and various other device components such as the display 25, the input/output unit 43 and/or the speaker 45, for example. In this regard, the component interface unit can include any number of different components such as one or more PIC microcontrollers, internal bus, USB connections and other such hardware capable of providing a direct link between the various components. Of course any other means for providing the two way communication between one or more of the device and/or controller elements are contemplated.

The power source 48 can include or comprise any suitable means for providing power to the device components. As such, the power source can include or comprise one or more DC batteries and/or a power adapter which can be connected with an external power source.

Although dimensions are not critical, in the preferred embodiment, the primary digital shelf units 20 can preferably include a length (distance between sides 21e and 21f) of approximately 28.25 inches and a height (distance between sides 21c and 21d) of approximately 4.5 inches. Such dimensions being suitable for allowing the shelf unit to be positioned along the entire width of a standard sized merchandise shelf, and to extend vertically upward from the top surface of the shelf. In this regard, the primary shelf units are anticipated for use on a prominent shelf within a display case (e.g., one that is located at or about eye level with an average sized adult). When so positioned, the larger sized display screen 25 can display dynamic content 25a such as advertisements to a user in order to attract the attention of the user to a particular product. Of course, any number of other shapes and sizes are also contemplated.

In the preferred embodiment, each of the secondary digital shelf tag units 20′ can include a somewhat smaller dimension, having a length (distance between sides 21e′ and 21f′) of approximately 28.25 inches and a height (distance between sides 21c′ and 21d′) of approximately 1.25 inches. Such dimensions being suitable for allowing the shelf unit to include a length and width that are complementary to the width and height of a standard sized merchandise shelf, respectively, so as to prevent the top surface of the unit from extending above the top surface of the shelf. In this regard, the secondary shelf units are anticipated for use on virtually any shelf containing merchandise and for displaying static pricing information for the same (See also FIG. 6). Of course, any number of other shapes and sizes are also contemplated.

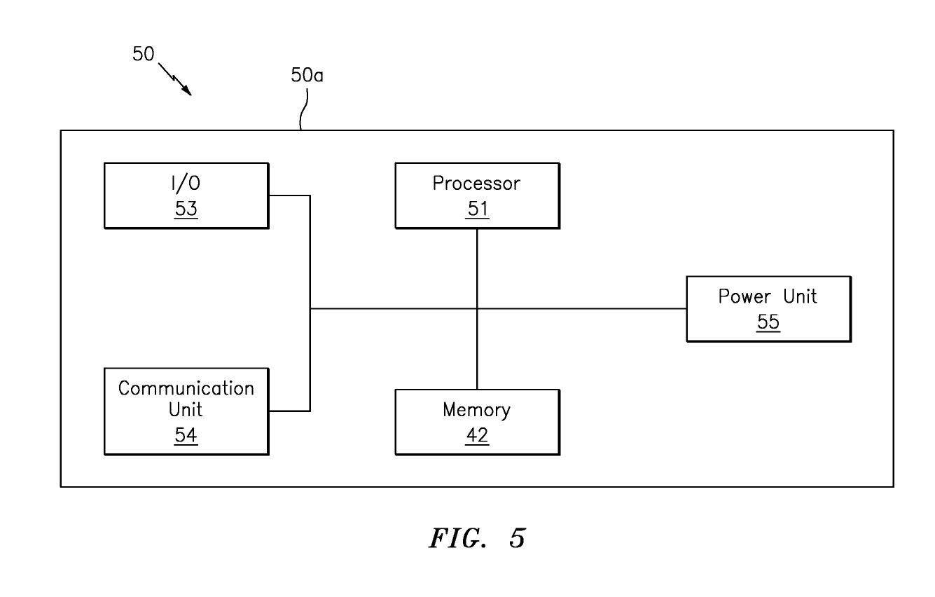

The system control unit 50 can function as a gatekeeper for allowing and/or facilitating communication between each of the digital shelf tag units and any number of authorized users 5a and 5b. As shown in the exemplary block diagram of FIG. 5, the system control unit 50 can include a main body 50a which also houses an internal processor 51, memory 52, input/output unit 53, a communication unit 54, and/or a power source 55. Such components being substantially identical to the processor, memory, I/O, communication unit and power source described above, therefore a duplicate description of these components will not be provided.

In the preferred embodiment, the system controller 50 can be provided with instructions for allowing any number of different authorized users to control different aspects of each of the digital shelf tag units 20 and/or 20′. For example, as shown in FIG. 1, the system controller 50 can communicate with a first authorized user 5a such as a product manufacturer, advertiser, and/or corporate office representative, for example, over a network 11 such as the internet. Such a feature can allow the remote user to provide content such as dynamic advertisements, for example, to be displayed on the central portion of the screen 25a and/or product specials such as a “2 for $5” deal to be displayed on sections 25b and 25e, for example. Such a feature advantageously allows such information to be immediately presented to customers at the store location without the need to physically dispatch a worker to provide such information to the store location.

In yet another embodiment, the system controller 50 can communicate with a second authorized user 5b such as a store employee, for example, in order to change or update information pertaining to products being represented by the system. Such items can be displayed, for example in the exemplary sections 25c, 25d, 25f, 25g and/or 25a′-25j′, for example. Such a feature advantageously removes the need for the store owner/operator to print individual pricing labels and further removes the labor costs associated with physically replacing paper tag equivalents. As noted above, the local user 5b can communicate with each of the digital shelf tag units through the system controller 50 and/or directly via an app or other such program that is installed onto a processor enabled device such as a smartphone or tablet, for example.

FIG. 6 illustrates one embodiment of the system 100 in operation. As shown, one or more of the digital shelf tag units 20 and/or 20′ can be secured onto a shelf 61 within a display case 62. When so located, the display screen of each of the digital shelf tag unit(s) can display content such as advertisements and/or pricing information pertaining to the items 65 on the shelf.

As described herein, one or more elements of each of the digital shelf tag units can be constructed and/or secured together utilizing any number of known manufacturing techniques and/or construction materials. Although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof. As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A digital shelf tag system, comprising:
at least one shelf tag unit that includes a main body having a front facing surface and an interior space,
a display screen that is positioned along the front facing surface of the main body,
an internal controller that is positioned within the interior space of the main body,
wherein the controller is in communication with the display screen and is configured to digitally segment the display screen into a plurality of distinct sections, and
a shelf attachment bracket that is in communication with the main body, said bracket including a first end that is configured to engage a merchandise shelf; and
a system control unit that includes functionality for enabling a plurality of authorized users utilizing one or more external devices to send content to each of the at least one shelf tag units.

2. The system of claim 1, wherein the internal controller of each of the at least one shelf tag unit includes a communication unit that is configured to directly communicate with an authorized user utilizing an external device to send content to the at least one shelf tag unit.

3. The system of claim 1, wherein the at least one shelf tag unit includes a primary shelf tag unit having a first dimension, a display screen and controller that are configured to display dynamic content.

4. The system of claim 3, wherein the at least one shelf tag unit includes a plurality of secondary shelf tag units, each of said secondary units including a display screen and a main body having a second dimension, said second dimension being less than the first dimension.

5. The system of claim 4, wherein the system control unit includes functionality for digitally segmenting the display screen of the plurality of secondary shelf tag units to conform to a dimension of a product located on a shelf.

6. The system of claim 1, further comprising:
a speaker that is configured to produce audible content.

7. The system of claim 1, further comprising:
a motion sensor that is configured to activate the display of each of the at least one shelf tag unit upon detecting movement.

8. The system of claim 1, wherein the shelf attachment bracket includes a joint for pivotally mounting the at least one shelf tag unit onto the merchandise shelf.

9. The system of claim 1, further comprising:
insulation that is positioned along the interior space of the main body, said insulation functioning to encompass the internal controller to provide thermal insulation thereto.

10. The system of claim 1, wherein the at least one shelf tag unit that comprises:
at least one primary shelf tag unit having a first dimension, a display screen and controller that are configured to display dynamic content; and
a plurality of secondary shelf tag units, each of said secondary units including a display screen and a main body having a second dimension, said second dimension being less than the first dimension,
wherein each of the primary and secondary shelf tag units are in electronic communication and are configured to receive content from each of the control unit and an authorized user via a direct connection.

11. The system of claim 1, wherein the internal communication unit is configured to send content to a consumer device.

12. The system of claim 11, wherein the display screen includes a touch screen display incorporating a graphic user interface, and the internal communication unit is configured to send the content to the consumer device upon receiving an instruction from the consumer via the two way interface.
